(19) United States
(12) Patent Application Publication
(10) Pub. No.: US 2009/0117286 A1
(43) Pub. Date: May 7, 2009

(54) Actinic Ray Curable Composition; and Actinic Ray Curable Ink, Image Forming Method and Ink-Jet Recording Apparatus Utilizing the Same

(75) Inventor: Wataru Ishikawa, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA MEDICAL & GRAPHIC, INC., Tokyo (JP)

(21) Appl. No.: 11/920,675

(22) PCT Filed: May 16, 2006
(86) PCT No.: PCT/JP2006/309687

§ 371 Date: Nov. 19, 2007

(30) Foreign Application Priority Data
May 25, 2005 (JP) 2005-152292

(51) Int. Cl. B05D 3/06; C09D 11/02; B41J 2/01

(52) U.S. Cl. 427/511; 252/182.14; 252/182.15; 347/102

(57) ABSTRACT

An actinic ray curable composition comprising a radical polymerizing monomer, wherein the radical polymerizing monomer contains a mono-functional monomer, a content of which is not less than 5 weight % and not more than 30 weight %, and further contains a silicone-containing compound or a fluorine-containing compound.

### FIELD OF THE INVENTION

The present invention relates to an actinic ray curable composition which cures at high sensitivity as well as being excellent in flexibility and hardness of the formed coated layer, and an actinic ray curable ink, an image forming method and an ink-jet recording apparatus, which utilize the same.

### BACKGROUND OF THE INVENTION

Up to now, a curable composition which cures via actinic rays such as ultraviolet rays and electron rays, or by heat, has been utilizeded in practice for various applications such as paints, adhesives and printing inks on such as plastics, paper, woodwork and inorganic materials; a printed circuit board and electrical insulating matters. In recent years, as for printing ink, paints and adhesives among them, further improvement of weather-proofing and adhesion to the substrate has been demanded. Further, as ink-jet ink utilizing these curable compositions ultraviolet curable ink which cures with ultraviolet rays is known. An ink-jet printing method utilizing this ultraviolet curable ink is attracting attention in recent years with respect to relatively weak odor, rapid drying and capability of recording on a recording medium without an ink absorptive property, and ultraviolet curable ink-jet ink (hereinafter, also simply referred to as ink) has been disclosed in such as JP-A 6-200204 (hereinafter, JP-A refers to Japanese Patent Publication Open to Public Inspection No.) and Japanese Translation of PCT International Patent Application Publication No. 2000-504778.

Ink employing a radical polymerizing compound generally suffers from an inhibition effect by oxygen to easily cause curing inhibition in the case of small ink droplet volume. Further, ink employing a cationic polymerizing compound (for example, refer to patent literatures 1-4), which does not suffer from a polymerization inhibition effect by oxygen, has a problem of being easily affected by water content (moisture) of a molecular level.

Further, in this field, it is required that formed film is strong and flexible in addition to having high curing ability. Ink utilizing radical polymerizing monomer has a problem that formed film is strong but poor in flexibility. To improve this flexibility, it is known that addition of mono-functional monomer is effective, however, there is a problem of extreme deterioration of film strength; development of actinic ray curable composition satisfying the both of film strength and flexibility of a coated layer has been required.

Patent literature 1: JP-A 2001-220526 (claims, examples)

Patent literature 2: JP-A 2002-188025 (claims, examples)

Patent literature 3: JP-A 2002-317139 (claims, examples)

Patent literature 4: JP-A 2003-55449 (claims, examples)

### SUMMARY OF THE INVENTION

### Problems to be Solved

This invention has been made in view of the above-described problems and the object is to provide an actinic ray curable composition which exhibits high sensitivity and can form a highly flexible and strong coated layer, and actinic ray curable ink, an image forming method and an ink-jet recording apparatus, which utilize the same.

### Means to Solve the Problems

The above-described object of this invention can be achieved by the following constitutions.

Item 1. An actinic ray curable composition comprising a radical polymerizing monomer,

wherein the radical polymerizing monomer contains a mono-functional monomer, a content of which is not less than 5 weights and not more than 30 weight %, and further contains a silicone-containing compound or a fluorine-containing compound.

Item 2. The actinic ray curable composition described in Item 1 above, wherein the radical polymerizing monomer is an acrylate compound or a methacrylate compound.

Item 3. The actinic ray curable composition described in Item 1 or 2 above, wherein the silicone-containing compound is a silicone oil.

Item 4. The actinic ray curable composition described in Item 3 above, wherein an amount of decrease in surface tension at 25° C. is 0-3 mN/m when 0.1 weight % of the silicone oil is incorporated based on the total weight of the composition.

Item 5. The actinic ray curable composition described in any one of Items 1-4 above, wherein the fluorine-containing compound is a fluorine-containing surfactant.

Item 6. The actinic ray curable composition described in Item 5 above, wherein the fluorine-containing surfactant is at least one type selected from fluorine-containing surfactants represented by Formulas (1)-(3):

Rf-(L₁)ₘ-(Y₁)ₙ—X Formula (1)

wherein Rf is an aliphatic group containing at least one fluorine atom; L₁ is a divalent connecting group; Y₁ is an alkylene oxide group or an alkylene group which may be provided with a substituent; X is a hydrogen atom, a hydroxyl group, an anionic group or a cationic group; m is 0 or an integer of 1-5, and n is 0 or an integer of 1-40,

Rf—(O—Rf′)ₙ₁-L₂-X′ₘ₁ Formula (2)

wherein Rf is an aliphatic group containing at least one fluorine atom; Rf′ is an alkylene group containing at least one fluorine atom; L₂ is a simple bonding hand or a connecting group; X′ is a hydroxyl group, an anionic group or a cationic group; and n1 and m1 are each an integer of not less than 1, and

[(Rf″O)ₙ₂—(PFC)—CO—Y₂]ₖ-L₃-X″ₘ₂ Formula (3)

wherein Rf″ is a perfluoroalkyl group containing 1-4 carbon atoms; (PFC) is a perfluorocycloalkylene group; Y₂ is a connecting group containing an oxygen atom or a nitrogen atom; L₃ is a simple bonding hand or a connecting group; X″ is a water-solubilizing polar group containing an anionic group, a cationic group, a nonionic group or an amphoteric group; n2 is an integer of 1-5; k is an integer of 1-3; and m2 is an integer of 1-5.

Item 7. The actinic ray curable composition described in any one of Items 1-6 above, wherein viscosity at 25° C. is not less than 7 mPa·s and not more than 40 mPa·s.

Item 8. An actinic ray curable ink comprising the actinic ray curable composition described in any one of Items 1-7 above, and the composition contains a pigment.

Item 9. An image forming method comprising the steps of:

(a) ejecting the actinic ray curable ink described in Item 8 from an ink-jet recording head onto a recording medium, and
(b) irradiating actinic rays to the ejected ink to print an image onto the printing medium,

wherein the actinic ray curable ink is irradiated by actinic rays during not less than 0.001 second and not more than 0.1 second after deposition of the ink.

Item 10. The image forming method described in Item 9 above, wherein a minimum droplet volume, which is ejected from each nozzle of the ink-jet-recording head, is not less than 2.0 pl and not more than 15 pl.

Item 11. An ink-jet recording apparatus utilized in the image forming method described in Item 9 or 10 above, wherein the actinic ray curable ink is ejected from an ink-jet recording head after the actinic ray curable ink and the ink-jet recording head are heated to and maintained at 35-100° C.

### Effects of the Invention

This invention can provide an actinic ray curable composition which generates no uncomfortable odor and exhibits improvement of abrasion resistance, bending resistance and depressed bleeding of a formed image as well as high curing sensitivity; and actinic ray curable ink, an image forming method and an ink-jet recording apparatus, which utilize the same.

### BRIEF DESCRIPTION OF THE DRAWINGS

FIG. 1 is a front view drawing to show an example of a constitution of the primary portion of an ink-jet recording apparatus utilizable in this invention.

FIG. 2 is an over view drawing to show another example of a constitution of the primary portion of an ink-jet recording apparatus of a line head type utilizable in this invention.

### DESCRIPTION OF SYMBOLS

1: Ink-jet recording apparatus
2: Head carriage
3: Ink-jet recording head
31: Ink ejection outlet
4: Irradiation means
5: Platen portion
6: Guide member
7: Bellows structure
P: Recording medium

### DETAILED DESCRIPTION OF THE INVENTION

In the following, the most preferable embodiment to practice this invention will be detailed.

<Radical Polymerizing Compounds>

Generally, a photo-polymerizing compound utilized in an actinic ray curable composition includes a radical polymerizing compound and a cationic polymerizing compound; however, in an actinic ray curable composition of this invention, it is characteristic to utilize a radical polymerizing compound.

In the following, a radical polymerizing compound will be explained.

A radical polymerizing compound according to this invention is a compound provided with an ethylenic unsaturated bond capable of radical polymerization in a molecule, which may be any compound provided with at least one ethylenic unsaturated bond capable of radical polymerization in a molecule, and specifically includes those having a chemical form of such as monomer, oligomer and polymer. A radical polymerizing compound may be utilized alone or may be utilized in combination of at least two types at an arbitrary ratio to improve an aimed characteristic.

In an actinic ray curable composition of this invention, one characteristic is to incorporate at least not less than 5 weight % and not more them 30 weight %, against the total weight of an actinic ray curable composition, of mono-functional monomer as a radical polymerizing compound, and the radical polymerizing monomer is preferably an acrylate compound or a methacrylate compound.

Monomer utilizable in an actinic ray curable composition of this invention is not specifically limited and includes a (meth)acrylate compound such as ethyl (meth)acrylate, butyl (meth)acrylate, 2-ethylhexyl (meth)acrylate, isooctyl (meth)acrylate, lauryl (meth)acrylate, isomyristyl (meth)acrylate, isostearyl (meth)acrylate, methoxyethyl (meth)acrylate, ethoxyethyl (meth)acrylate, methylcarbitol (meth)acrylate, ethylcarbitol (meth)acrylate, phnoxy (meth)acrylate, methoxydipropyleneglycol (meth)acrylate, dimethylamino (meth)acrylate and morpholinoethyl (meth)acrylate; and an (meth)acrylamide compound such as N,N-dimethyl (meth)acrylamide and N,N-dimethylaminopropyl (meth)acrylamide. Further, a hydroxyl group containing (meth)acrylate compound such as 2-hydroxyethyl (meth)acrylate, 2-hydroxypropyl (meth)acrylate, 4-hydroxybutyl (meth)acrylate, 2-hydroxybutyl (meth)acrylate, 3-chloro-2-hydroxypropyl (meth)acrylate, epichlorohydrin modified butyl (meth)acrylate, glycerol (meth)acrylate, caprolactone modified 2-hydroxyethyl (meth)acrylate and phenoxyhydroxypropyl (meth)acrylate may be utilized. These mono-functional radical polymerizing monomer may be utilized alone or in combination by mixing at least two types.

In an actinic ray curable composition of this invention, together with mono-functional monomer, utilized can be monomer of not less than bi-functional, which includes bi-functional monomer such as triethylene diacrylate, tetraethyleneglycol diacrylate, polyethyleneglycol diacrylate, tripropyleneglycol diacrylate, polypropyleneglycol diacrylate, 1,4-butanediol diacrylate, 1,6-hexanediol diacrylate, 1,9-nonanediol diacrylate, neopentylglycol diacrylate, dimethyloltricyclodecane diacrylate, EO adduct diacrylate of bisphenol A, PO adduct acrylate of bisphenol A, hydroxypivalic acid neopentylglycol diacrylate and polytetramethyleneglycol diacrylate; and poly-functional, not less than tri-functional, monomer of such as trimethylolpropane triacrylate, EO modified trimethylolpropane triacrylate, pentaerythritol triacrylate, pentaerythritol tetraacrylate, dipentaerythritol hexaacrylate, ditrimethylolpropane tetraacrylate, glycerinpropoxy triacrylate, caprolactone modified trimethylolpropane triacrylate, pentaerythritolethoxy tetraacrylate and caprolactam modified dipentaerythritol hexaacrylate; in addition to these, listed are derivatives of an allyl compound such as allylglycidyl ether, diallylphthalate and triallyltrimellitate; and further specifically, radical polymerizing or cross-linking monomer, oligomer and polymer available on the market or well known in the art, which are described in such as “Handbook of Cross-linking Agents” (Taiseisha, 1981) by Shinzo Yamashita, “Handbook of UV•EB Curing (Starting Materials)” (Polymer Publishing Association, 1985) edited by Kiyomi Kato, “Application and Market of UV•EB Curing Technology” p. 79 (CMC, 1989) edited by Radotech Study Group, and “Polyester Resin Handobook” (Nikkan Kogyo News, Paper, 1988) by Eiichiro Takiyame. An addition amount of the above-described radical polymerizing compound is preferably 5-97 weight % and more preferably 30-95 weight %.

<Other Photo-Polymerizing Compound>

In an actinic ray curable composition of this invention, a compound having an oxyrane group can be utilized in combination, with respect to improvement of curing ability and ejection stability.

As a polymerizing compound having an oxyrane group, various types of cationic polymerizing monomer well known in the art can be utilized. For example, listed are epoxy compounds, vinyl ether compounds and oxetane compounds which are exemplified in JP-A Nos. 6-9714, 2001-31892, 2001-40068, 2001-55507, 2001-310938, 2001-310937 and 2001-220526.

An epoxy compound includes such as the following aromatic epoxide, alicyclic epoxide and aliphatic epoxide.

An aromatic epoxide is preferably di- or poly-glycidyl ehther manufactured by a reaction of polyhydric phenol having at least one aromatic nucleus or an alkylene oxide adduct thereof with epichlorohydrin, and includes such as di- or poly-glycidyl ether of bisphenol A or an alkylene oxide adduct thereof, di- or poly-glycidyl ether of hydrogenated bisphenol A or an alkylene oxide adduct thereof and novolac type epoxy resin. Herein, alkylene: oxide includes such as ethylene oxide and propylene oxide.

An alicyclic epoxide is preferably a compound containing cyclohexene oxide or cyclopentene oxide which is prepared by epoxidation of a compound, having at least one cycloalkane ring such as a cyclohexene or cyclopentene ring, by use of such as hydrogen peroxide and peracid.

An aliphatic epoxide is preferably di- or poly-glycidyl ether of aliphatic polyhydric alcohol or an alkylene oxide adduct thereof, and typical examples include diglycidyl ether of alkylene glycol such as diglycidyl ether of ethylene glycol, diglycidyl ether of propylene glycol or diglycidyl ether of 1,6-hexanediol; polyglycidyl ether of polyhydric alcohol such as di- or tri-glycidyl ether of glycerin or alkylene oxide adduct thereof; and diglycidyl ether of polyalkylene glycol such as diglycidyl ether of polyethylene glycol or an alkylene oxide adduct thereof and diglycidyl ether of polypropylene glycol or an alkylene oxide adduct thereof. Herein, alkylene oxide includes ethylene oxide and propylene oxide.

Among these epoxides, aromatic epoxide and alicyclic epoxide are preferable and alicyclic epoxide is specifically preferable, in consideration of rapid curring ability. In this invention, one type of the above-described epoxide may be utilized alone; however, at least two types may be also utilized in appropriate combination.

Further, in this invention, at least one of epoxidated fatty acid ester and epoxidated fatty acid glyceride is specifically preferable as an epoxy compound having an oxyrane group with respect to safety such as AMES and sensitizing.

As epoxidated fatty acid ester and epoxidated fatty acid glyceride, those in which an epoxy group is introduced in to fatty acid ester and fatty acid glyceride can be utilized without specific limitation. Epoxidated fatty acid ester is those manufactured by epoxidation of oleic acid ester, and such as methyl epoxystearate, butyl epoxystearate and octyl epoxystearate are utilized. Further, epoxidated fatty acid glyceride is similarly those manufactured by epoxidation of such as soybean oil, linseed oil and castor oil, and such as epoxidated soybean oil, epoxidated linseed oil and epoxidated castor oil are utilized.

Further, in this invention, it is preferable to incorporate 30-95 weight % of a compound having an oxetane ring, 5-70 weight % of a compound having an oxyrane compound and 0-40 weight % of a vinyl ether compound respectively, with respect to further improvement of curing ability and ejection stability.

An oxetane compound utilizable in this invention includes every oxetane compound well known in the art such as introduced in JP-A Nos. 2001-220526 and 2001-310937.

A vinyl ether compound utilizable in this invention includes di- or tri-vinyl ether compounds such as ethylene glycol divinyl ether, diethylene glycol divinyl ether, triethylene glycol divinyl ether, propylene glycol divinyl ether, dipropylene glycol divinyl ether, butane diol divinyl ether, hexane diol divinyl ether, cyclohexane dimethanol divinyl ether and trimethylolpropane trivinyl ether; and monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexane dimethanol monovinyl ether, n-propyl vinyl ether, isopropyl vinyl ether, isopropenyl ether-O-propylene carbonate, dodecyl vinyl ether, diethylene glycol monovinyl ether and octadecyl vinyl ether.

Among these vinyl ether compounds, a di- or tri-vinyl ether compound is preferable and a divinyl ether compound is specifically preferable, in consideration of curing ability, adhesion and surface hardness. In this invention, one type of the above-described vinyl ether compound may be utilized alone; however, at least two types may be also utilized in appropriate combination.

<Radical Polymerization Initiator>

As a radical polymerization initiator, listed are triazine derivatives described in such as Examined Japanese Patent Application Publication Nos. 59-1281 and 61-9621 and JP-A 60-60104; organic peroxides described in such as JP-A Nos. 59-1504 and 61-243807; diazonium compounds described in such as of Examined Japanese Patent Application Publication Nos. 43-23684, 44-6413, 47-1604 and U.S. Pat. No. 3,567,453; organic azide compound described in U.S. Pat. Nos. 2,848,328, 2,852,379 and 2,940,853; orthoquinone diazides described in such as Examined Japanese Patent Application Publication Nos. 36-22062, 37-13109, 38-18015 and 45-9610; various types of onium compounds described in such as of Examined Japanese Patent Application Publication No. 55-39162, JP-A 59-14023 and “Macromolecules” vol. 10, p. 1307 (1977); azo compounds described in JP-A 59-142205; metal allene complexes described in JP-A 1-54440, European Patent Nos. 109,851 and 126,712, and J. Imag. Sci. vol. 30, p. 174 (1986); (oxo)sulfonium organo-boron complexes described in JP-A Nos. 4-213861 and 4-255347; titanocenes described in JP-A 61-151197; transition metal complexes containing a transition metal such as ruthenium described in “Corodination Chemistry Review” vol. 84, PP. 85-277 (1988) and JP-A 2-182701; 2,4,5-tiarylimidazole dimmer described in JP-A 3-209477; and organic halogen compounds such as carbon tetrabromide and those described in JP-A 59-107344. These polymerization initiators are preferably incorporated in a range of 0.01-10 weight parts against 100 weight parts of a compound provided with an ethylenic unsaturated bond capable of radical polymerization.

<Fluorine Type Surfactant>

An actinic ray curable composition of this invention is characterized by containing a silicone-containing compound or a fluorine-containing compound, wherein a fluorine-containing compound is preferably a fluorine type surfactant and a fluorine type surfactant is more preferably at least one type selected from fluorine type surfactants represented by following Formulas (1)-(3).

In the following, fluorine type surfactants represented by Formulas (1)-(3) will be explained.

Rf-(L₁)ₘ-(Y₁)ₙ—X Formula (1)

In Formula (1), Rf is an aliphatic group containing at least one fluorine atom; L₁ is a divalent connecting group; Y₁ is an alkylene oxide group or an alkylene group which may be provided with a substituent; X is a hydrogen atom, a hydroxyl group, an anionic group or a cationic group; m is 0 or an integer of 1-5; and n is 0 or an integer of 1-5.

Rf—(O—Rf′)ₙ₁-L₂-X′ₘ₁ Formula (2)

In Formula (2), Rf is an aliphatic group containing at least one fluorine atom; L₂ is a simple bonding hand or a connecting group; X′ is a hydroxyl group, an anionic group or a cationic group; and n1 and m1 each are an integer of not less than 1.

[(Rf′O)ₙ₂—(PFC)—CO—Y₃]ₖ-L₃-X″ₘ₂ Formula (3)

In Formula (3), Rf″ is a perfluoroalkyl group containing 1-4 carbon atoms, (PFC)) is a perfluorocycloalkylene group; Y₃ is a connecting group containing an oxygen atom or a nitrogen atom; L₃ is a simple bonding hand or a connecting group; X′″ is a water-solublizing polar group containing an anionic group, a cationic group, a nonionic group or an amphoteric group; n2 is an integer of 1-5; k is an integer 1-3 and m2 is an integer of 1-5.

In above-described Formulas (1) and (2), Rf is an aliphatic group containing at least one fluorine atom, and the aliphatic group preferably has a carbon number of 1-18, more preferably has a carbon number of 2-12 and specifically preferably has a carbon number of 3-7.

In Formula (1), L₁ is a divalent connecting group, and the divalent connecting group is specifically preferably a sulfonamide group, an alkylene oxide, group, a phenoxy group or an alkylene carbonyl group.

In Formula (1), Y₁ is an alkylene oxide group or an alkylene group which may be provided with a substituent; the alkylene oxide group includes such as an ethylene oxide group and a propylene oxide group and an ethylene oxide group is specifically preferable. Further said alylene group includes a methylene group, an ethylene group and a propylene group, and an ethylene group is specifically preferable.

In Formula (1), X is a hydrogen atom, a hydroxyl group, an anionic group or a cationic group; an anionic group is preferably a carboxyl group, a sulfonic acid group or a phosphoric acid group and a counter, anion of said anionic group is preferably such as an alkali metal ion such as a sodium ion and a potassium ion or an ammonium ion. Further, a cationic group is preferably such as a quaternary alkyl ammonium group, and a counter anion of said cationic group is preferably such as a halogenide ion and p-toluenesulfonic acid ion.

In Formula (1), m is 0 or an integer of 1-5 and n is 0 or an integer of 1-40, however, it is specifically preferable that m is 0 and n is 10-20.

In Formula (2), Rf′ is an alkylene group containing at least one fluorine atom; and the carbon number thereof is preferably 1-8, more preferably 2-5 and specifically preferably 2 or 3.

In Formula (2), L₂ is a simple bonding hand or a connecting group, and said connecting group is preferably an alkylene group, an arylene group or a divalent group containing a hetero atom.

In Formula (2), X′ is a hydroxyl group, an anionic group or a cationic group; an anionic group is preferably a carboxyl group, a sulfonic acid group or a phosphoric acid group, a counter anion of said anionic group is preferably an alkali metal ion such as a sodium ion and a potassium ion or an ammonium ion. Further, a cationic group is preferably a quaternary alkyl ammonium group, and a counter anion of said cationic group is preferably a halogenide ion and a p-toluenesulfonic acid ion.

In Formula (2), n1 and m1 each are an integer of not less than 1, however, it is preferable that n1 is not less than 1 and not more than 10 and m1 is not less than 1 and not more than 3.

In Formula (3), Rf″ is a perfluoroalkyl group having a carbon number of 1-4, however, the perfluoroalkyl group is specifically preferably a trifluoromethyl group.

In Formula (3), (PFC) is a perfluorocycloalkylene group, which includes such as a perfluorocyclooctylene group, a perfluorocycloheptylene group, a perfluorocyclohexylene group and a perfluorocyclopentylene group, and perfluorocyclohexylene group is specifically preferable.

In Formula (3), Y₂ is a connecting group containing an oxygen atom or a nitrogen atom, and the connecting group is specifically preferably —OCH₃— or —NHCH₂—.

In Formula (3), L₃ is a simple bonding hand or a connecting group, and the connecting group includes a poly- and generally di-valent connecting group such as substituted or unsubstituted alkylene (such as ethylene, n-propylene or isobutylene), arylene (such as phenylene), a combination of alkylene and arylene (such as xylene), oxydialkylene (such as CH₂CH₂OCH₂CH₂) and thiodialkylene (such as CH₂CH₂SCH₂CH₂).

In Formula (3), X″ is a water-solubilizing group containing an anionic group, a cationic group, a nonionic group or an amphoteric group, and an anionic group includes such as CO₂H, CO₂M, SO₃H, SO₃M, OSO₃H, OSO₃M, (OCH₂CH₂) OSO₃M, OPO(OH)₂ and OPO(OM)₂ (wherein, M is a metal ion such as sodium, potassium and calcium, or an ammonium ion); among them, a carboxyl group, a sulfonic acid group or a phosphoric acid group is preferable and a counter cation of the anionic group is preferably an alkali metal ion such as a sodium ion and a potassium ion or an ammonium ion. A cationic group is preferably a quaternary ammonium group and a counter anion of the cationic group is preferably such as a halogenide ion and a p-toluenesulfonic acid ion. Further, a nonionic group is preferably a hydroxyl group.

In Formula (3), n2 is an integer of 1-5, k is an integer of 1-3 and m2 is an integer of 1-5; and it is specifically preferable that n2 is 3, k is 1 or 2 and m is 1.

In the following, specific examples of a fluorine type surfactant which are utilizable in this invention will be shown; however, this invention is not limited thereto.

<Specific Examples of Fluorine Type Surfactant represented by Formula (1)>

1-1. C₈F₁₇SO₃K

1-2. C₈F₁₇SO₃Li

1-3. C₈F₁₇COONH₄

1-4. C₈F₁₇COOK

1-5. C₉F₁₉—O—C₆H₄—SO₃K

1-6. C₉F₁₉—O—C₆H₄—SO₃Na

1-7. C₆F₁₃—O—C₆H₄—SO₃K

1-8. C₆F₁₃—O—C₆H₄—SO₃Na

1-9. C₇F₁₅COONH₄

1-10. NaO₃S(CH(CHCOOCH₂CH₂C₈F₁₇) COOCH₂CH₂C₈F₁₇)

1-11. C₈F₁₇SO₂N(C₃H₇) (CH₂COOK)

1-12. C₈F₇SO₂N(C₃H₇) (CH₂CH₂OPO₃Na₂)

1-13. C₈F₁₇SO₂N(C₁₂H₂₅) ((C₂H₄O)₄C₄H₈SO₃Na)

1-14. C₆F₁₃CH₂CH₂SO₃NH₄

1-15. CF₃CF₂ (CF₂CF₂)₃CH₂CH₂SO₃NH₄

1-16. CF₃CF₂ (CF₂CF₂)₄CH₂CH₂SO₃NH₄

1-17. C₆F₁₃CH₂CH₂O—PO(ONH₄)₂

1-18. C₆F₃CH₂CH₂O—PO(ONH₄) (OCH₂CH₂OH)

1-19. C₂F₅(CH₂)₆SO₃NH₄

1-20. C₃F₇(CH₂)₅SO₃NH₄

1-21. C₂F₅(CH₂)₆COOLi

1-22. C₃F₇(CH₂)₃O—C₆H₄—SO₃K

1-23. NaO₃S(CH(CHCOO(CH₂)₉C₃F₇)COO(CH₂)₉C₃F₇)

1-24. C₃F₇ (CH₂)₅SO₂N(C₃H₇) (CH₂COOK)

1-25. C₃F₇ (CH₂)₅SO₂N(C₁₂H₂₅)((C₂H₄O)₄C₄H₈SO₃Na)

1-26. (C₂F₅CH₂O)₂PO(OH)₂

1-27. C₃F₇CH₂CH₂OPO(OH)₂

1-28. C₃F₇CH₂CH₂SCH₂CH₂COOLi

1-29. C₆F₁₃CH₂CH₂SCH₂CH₂COOLi

1-30. (C₆F₁₃CH₂CH₂O)₂PO(OH)₂

1-31. C₆F₁₃CH₂CH₂O—(CH₂CH₂O)₁₀—H

1-32. C₈F₁₇CH₂CH₂O—(CH₂CH₂O)₁₂—H

1-33. C₁₀F₂₁CH₂CH₂O—(CH₂CH₂O)₈—H

1-34. C₄F₉CH₂CH₂O—(CH₂CH₂O)₂₀—H

1-35. C₃F₇CH₂CH₂O—(CH₂CH₂O)₁₀—H

1-36. C₃F₇CH₂CH₂O—(CH₂CH₂O)₁₂—H

1-37. C₂F₅CH₂CH₂O—(CH₂CH₂O)₁₅—H

1-38. C₃F₇—(CH₂CH₂O)₂—(CH₂C(OH)H—CH₂O)₁₀—H

1-39. C₄F₉—CH(CH₃) CH₂O—(CH₂CH₂O)₉—H

1-40. C₆F₁₃—(CH₂CH₂O)₃—(CH₂C(OH)H—CH₂O)₁₂—H

1-41. C₃F₇CH₂CH₂O—(CH₂CH₂O)₃₁—H

<Specific Examples of Fluorine Type Surfactant represented by Formula (2)>

2-1. C₅F₁₁(OCF₂)OPO(ONa)₂

2-2. HC₆F₁₂(OCF₂)OPO(ONa)₂

2-3. C₈F₁₇(OCF₂)OPO(ONa)₂

2-4. C₁₀F₂₁(OCF₂)OPO(ONa)₂

2-5. C₁₂F₂₅(O—CF₂)OPO(ONa)₂

2-6. C₃F₇(OC₂F₄)OPO(ONa)₂

2-7. C₄F₉(OC₂F₄)OPO(ONa)₂

2-8. C₁₁(OC₂F₄)OPO(ONa)₂

2-9. H—C₆F₁₂-(OC₂F₄)—OPO(ONa)₂

2-10. C₇F₁₅(OC₂F₄)OPO(ONa)₂

2-11. C₉F₁₉(OC₂F₄)OPO(ONa)₂

2-12. C₁₁F₂₃(OC₂F₄)OPO(ONa)₂

2-13. C₃F₇ (OCF₂)₆OPO(ONa)₂

2-14. C₄F₉(OCF₂)₆OPO(ONa)₂

2-15. C₅F₁₁-(O—CF₂)₅—O—PO(ONa)₂

2-16. H—C₆F₁₂-(OCF₂)₃OPO(ONa)₂

2-17. C₃F₇O(CF₂)₃COONa

2-18. C₄F₉O(CF₂)₃COONa

2-19. C5F₁₁O(CF₂)₃COONa

2-20. H—C₇F₁₄—[O(CF₂)₃]—OCH(COONa)₂

2-21. C₈F₁₇O(CF₂)₃OCH(COONa)₂

2-22. C₃F₇O(CF₂)₅COONa

2-23. C₄F₉O(CF₂)₅COONa

2-24. C₅F₁₁O(CF₂)₅COONa

2-25. C₇F₁₅O(CF₂)₅COONa

2-26. C₃F₇ (OC₂F₄)₅COONa

2-27. C₄F₉(OC₂F₄)₂COONa

2-28. C₅F₁₁—(O—C₂F₄)₂—COONa

2-29. H—C₇F₁₄(OC₂F₄)₂COONa

2-30. C₉F₁₉(OC₂F₄)₂COONa

2-31. C₂F₅(OC₂F₄)₃COONa

2-32. C₂F₅(OC₂F₄)₅COONa

2-33. C₃F₇(OC₂F₄)₄COONa

2-34. C₄F₉(OC₂F₄)₃COONa

2-35. C₅F₁₁(OC₂F₄)₃NHCOCH(COONa)₂

2-36. H—C₆F₁₂ (OC₂F₄)₃NHCOCH(COONa)₂

2-37. C₄F₉ (OC₂F₄)₂OCF₂COONa

2-38. C₅F₁₁(OC₂F₄)₂OCF₂COONa

2-39. C₇F₁₅ (OC₂F₄)₂OCF₂COONa

2-40. C₄F₉—OCF₂—[O(CF₂)₅]—COOK

2-41. C₅F₁₁—OCF₂—[O(CF₂)₅]—COOK

2-42. H—C₆F₁₂—OCF₂—[O(CF₂)₅]—COOK

2-43. C₄F₉—(OC₂F₄)₅—[O(CF₂)₃]—COOK

2-44. C₅F₁₁—(OC₂F₄)₂—[O(CF₂)₃]—COOK

2-45. C₆F₁₃—(OC₂F₄)₂—[O—(CF₂)₃]—COOK

2-46. C₁₂F₂₅OCF₂OSO₃Na

2-47. C₇F₁₅OC₂F₄OC₃H₆SO₃Na

2-48. C₄F₉—(OCF₂)₆—OSO₃Na

2-49. H—C₅F₁₀—(OCF₂)₅—OC₃H₆SO₃Na

2-50. H—C₆F₁₂—(OCF₂)₃—OSO₃Na

2-51. C₅F₁₁—(OC₂F₄)₂—OC₃H₆SO₃Na

2-52. C₇F₁₅—(OC₂F₄)₂—OSO₃Na

2-53. C₃F₇—(OC₂F₄)₄—OC₃H₆—SO₃Na

2-54. C₄F₉—(OC₂F₄)₃—O—SO₃Na

2-55. H—C₅F₁₀—(OC₂F₄)₃—OC₃H₆—SO₃Na

2-56. C₅F₁₁OCF₂—[O(CF₂)₅]—OSO₃Na

2-57. C₄F₉—(OC₂F₄)₂—[O(CF₂)₃]—OSO₃Na

2-58. (HCF₂)₃C—(OC₂F₄)₃—OSO₃Na

2-59. (CF₃)₂CFCF₂CF₂—(OCF₂)₅—OC₃H₆—SO₃Na

2-60. C₁₁F₂₃(OC₂F₄)OSO₃Na

2-61. C₄F₉—(OC₂F₄)₃—NHCO—(CH₂)₃—N⁺(CH₃)₃.Br⁻

2-62. C₅F₁₁—(OC₂F₄)₂—NHCO—(CH₂)₃—N⁺(CH₃)₃.Br⁻

2-63. HC₆F₁₂—(OC₂F₄)₂—NHCO—(CH₂)₃—N⁺(CH₃)₃.Br⁻

2-64. C₄F₉—(OC₂F₄)₃—OCH₂—N⁺(CH₃)₂(C₂H₄OH).Br⁻

2-65. C₅F₁₁—(OC₂F₄)₂—OCH₂—N⁺(CH₃)₂(C₂H₄OH).Br⁻

2-66. HC₆F₁₂—(OC₂F₄)₂—OCH₂—N⁺(CH₃)₂(C₂H₄OH).Br⁻

2-67. C₅F₁₁—OCF₂—(OC₂F₄)—NHCO— (CH₂)₃—N⁺(CH₃)₃.Br⁻

2-68. (CF₃)₃C—(OC₂F₄)₃—OCH₂—N⁺(CH₃)₂(C₂H₄OH).Br⁻

2-69. C₁₂F₂₅OCF₂OH

2-70. C₇F₁₅OC₂F₄OH

2-71. C₄F₉—(OCF₂)₆—OC₃H₆OH

2-72. C₅F₁₁—(OCF₂)₅—OC₃H₆OH

2-73. HC₆F₁₂—(OCF₂)₃—OH

2-74. C₅F₁₁—(OC₂F₄)₂—OC₃H₆OH

2-75. C₇F₁₅—(OC₂F₄)₂—OC₃H₆OH

2-76. C₃F₇—(OC₂F₄)₄—OC₃H₆OH

2-77. HC₄F₈—(OC₂F₄)₃—OC(C₂H₄OH)₃

2-78. C₅F₁₁—(OC₂F₄)₃—OC₃H₆OH

2-79. C₅F₁₁OCF₂O(CF₂)₅OH

2-80. C₄F₉—(OC₂F₄)₂—O(CF₂)₃OH

2-81. (CF₃)₃C—(OC₂F₄)₃—OH

2-82. (HCF₂)₂CFCF₂CF₂—(OCF₂)₅—OH

2-83. C₁₁F₂₃(OC₂F₄)₄OH

A synthesis method of the above-described compounds represented by Formula (2) can be referred to Japanese Translation of PCT International Application Publication Nos. 10-500950 and 11-504360.

<Specific Examples of Fluorine Type Surfactant represented by Formula (3)>

3-1. (CF₃O)₃—(PFC)—CONHC₃H₆N⁺(CH₃)₂C₂H₄COO⁻

3-2. (CF₃O)₃—(PFC)—CONHC₃H₆N⁺(CH₃)₂C₂H₄SO₃⁻

3-3. (CF₃O)—(PFC)—CONHC₃H₆N⁺(CH₃)₂C₂H₄SO₃⁻

3-4. (CF₃O)₃—(PFC)—CON(C₃H₆SO₃⁻)C₃H₆N⁺(CH₃)₂H

3-5. (CF₃O)—(PFC)—CON(C₃H₆SO₃⁻)C₃H₆N⁺(CH₃)₂H

3-6. [(CF₃O)₃—(PFC)—COOCH₂]₂CH—CONHC₃H₆N⁺(CH₃)₂C₂H₄SO₃⁻

3-7. [(CF₃O)₂—(PFC)—COOCH₂]₂CH—CONHC₃H₆N⁺(CH₃)₂C₂H₄SO₃⁻

3-8. [(CF₃O)—(PFC)—COOCH₂]₂CH—CONHC₃H₆N⁺(CH₃)₂C₂H₄SO₃⁻

3-9. (CF₃O)₃—(PFC)—CONHC₃H₆N⁺(CH₃)₂C₂H₄OH.Cl⁻

3-10. (CF₃O)₂—(PFC)—CONHC₃H₆N⁺(CH₃)₂C₂H₄OH.Cl⁻

3-11. (CF₃O)—(PFC)—CONHC₃H₆N⁺(CH₃)₂C₂H₄OH.Cl⁻

3-12. (CF₃O)₃—(PFC)—CONHC₃H₆N⁺(CH₃)₂H.Cl⁻

3-13. (CF₃O)₂—(PFC)—CONHC₃H₆N⁺(CH₃)₂H.Cl⁻

3-14. (CF₃O)—(PFC)—CONHC₃H₆N⁺(CH₃)₂H.Cl⁻

3-15. [(CF₃O)₃—(PFC)—COOCH₂]₂C(CH₃)N⁺(CH₃)₂H.Cl⁻

3-16. [(CF₃O)₂—(PFC)—COOCH₂]₂C(CH₃)N⁺(CH₃)₂H.Cl⁻

3-17. [(CF₃O)—(PFC)—COOCH₂]₂C(CH₃)N⁺(CH₃)₂H.Cl⁻

3-18. [(CF₃O)₃—(PFC)—COOCH₂]₂CHC₃H₆N⁺(CH₃)₂H.Cl⁻

3-19. [(CF₃O)₂—(PFC)—COOCH₂]₂CHC₃H₆N⁺(CH₃)₂H.Cl⁻

3-20. [(CF₃O)—(PFC)—COOCH₂]₂CHC₃H₆N⁺(CH₃)₂H.Cl⁻

3-21. (CF₃O)₃—(PFC)—COO(C₂H₄O)₁₂H

3-22. (CF₃O)₂—(PFC)—COO(C₂H₄O)₁₂H

3-23. (CF₃O)—(PFC)—COO(C₂H₄O)₁₂H

3-24. (CF₃O)₃—(PFC)—COO(C₂H₄O)₁₅CH₃

3-25. (CF₃O)₂—(PFC)—COO(C₂H₄O)₁₅CH₃

3-26. (CF₃O)—(PFC)—COO(C₂H₄O)₁₅CH₃

3-27. [(CF₃O)₃—(PFC)—COOCH₂]₂CHC₃H₆OH

3-28. [(CF₃O)₂—(PFC)—COOCH₂]₂CHC₃H₆OH

3-29. [(CF₃O)—(PFC)—COOCH₂]₂CHC₃H₆OH

3-30. (CF₃O)₃—(PFC)—CONHC₃H₆COONa

3-31. (CF₃O)₂—(PFC)—CONHC₃H₆COONa

3-32. (CF₃O)—(PFC)—CONHC₃H₆COOK

3-33. (CF₃O)₃—(PFC)—CONHC₃H₆SO₃Na

3-34. (CF₃O)₂—(PFC)—CONHC₃H₆SO₃Na

3-35. (CF₃O)—(PFC)—CONHC₃H₆SO₃K

3-36. (CF₃O)₃—(PFC)—CON(C₃H₆SO₃Na)C₃H₇

3-37. (CF₃O)₂—(PFC)—CON(C₃H₆SO₃Na)C₃H₇

3-38. (CF₃O)—(PFC)—CON(C₃H₆SO₃Na)C₃H₇

3-39. [(CF₃O)₃—(PFC)—COOCH₂]₂C(CH₃)COONa

3-40. [(CF₃O)₂—(PFC)—COOCH₂]₂C(CH₃)COONa

3-41. [(CF₃O)— (PFC)—COOCH₂]₂C(CH₃)COONa

3-42. [(CF₃O)₃—(PFC)—COOCH₂]₂C(COONa)₂

3-43. [(CF₃O)₂—(PFC)—COOCH₂]₂C(COONa)₂

3-44. [(CF₃O)—(PFC)—COOCH₂]₂C(COONa)₂

3-45. [(CF₃O)₃—(PFC)—COOCH₂]₂C(CH₃)SO₃Na

3-46. [(CF₃O)₂—(PFC)—COOCH₂]₂C(CH₃)SO₃Na

3-47. [(CF₃O)—(PFC)—COOCH₂]₂C(CH₃)SO₃Na

3-48. [(CF₃O)₃—(PFC)—COOCH₂]₂CHC₃H₆SO₃Na

3-49. [(CF₃O)₂—(PFC)—COOCH₂]₂CHC₃H₆SO₃Na

3-50. [(CF₃O)—(PFC)—COOCH₂]₂CHC₃H₆SO₃Na

Herein, in the above examples, (PFC) is a perfluorocyclohexylene group, the substitution position of (CF₃O) is 3-, 4- and 5-positions in the case of (CF₃O)₃, 3- and 4-positions in the case of (CF₃O)₂ and the 4-position in the case of (CF₃O), when the substitution position of a carbonyl group is 1-position.

A synthesis method of the above-described compounds represented by Formula (3) can be referred to JP-A 10-158218 and Japanese Translation of PCT International Application Publication No. 2000-505803.

This invention relates to actinic ray curable ink containing a photo-polymerizing compound and a colorant. By incorporating at least one type of cl fluorine type surfactant represented by aforesaid Formulas (1)-(3) in actinic ray curable ink containing a photo-polymerizing compound and a colorant, improved is a conventional problem that a dot size after ink deposition is largely varied depending on types of the aforesaid recording medium and operating environment to make highly precise and high quality printing on various recording media impossible. Ink of this invention is cured by irradiation of actinic rays after ink deposition on a recording medium, and the above-described problem is solved by employing actinic ray curable ink containing a fluorine type surfactant represented by aforesaid Formulas (1)-(3) according to this invention; this is considered to be related to a state of leveling of ink droplets ejected from a recording head, after having adhered on a recording medium until having cured with actinic ray irradiation.

<Silicone Oil>

An actinic ray curable composition of this invention is characterized by incorporating a silicone-containing compound or a fluorine-containing compound, and the silicone-containing compound is preferably silicone oil. Heretofore, actinic ray curable ink containing modified silicone oil has been known; however, modified silicone oil which significantly decreases surface tension of ink is utilized in any case and ejection stability and highly precise image formation cannot be compatible in various printing environment. Only by employing a constitution of this invention, stable ejection behavior can be achieved as well as easy control of a dot size of ink after ink deposition on a recording medium becomes possible.

Silicone oil (particularly modified silicone oil) utilized in this invention will be explained.

Silicone oil utilized in this invention is preferably a compound to show surface tension decrease of ink at 25° C. in a range of 0-3 mN/m when being contained in ink at 0.1 weight % against 100 weight % of an ink composition. When decrease width is not less than 3 mN/m, ejection stability and control of a dot size are not compatible.

Specific examples of modified silicone oil applicable to this invention include SDX-1843 (polyether modified silicone) manufactured by Asahi Denka Kogyo Co., Ltd. And XF42-334 (alkylaralkyl modified silicone oil) manufactured by GE Toshiba Silicone Corp., and for example, decrease width when 0.1 weight % thereof is container in 100 weight % of such as an epoxy compound (such as Celloxide 2021P manufactured by Daicel Chemical Industries Ltd.) and an oxetane compound (such as OXT-221 manufactured by Toacgosei Co., Ltd.) is less than 0.5 mN/m.

An addition amount of modified silicone oil in an actinic ray curable composition or actinic ray curable ink is preferably 0.01-1.0 weight % against 100 weight % of an ink composition, and the effect is small at less than 0.01 weight % while ejection may become unstable at over 1.0 weight %.

<Pigment, Viscosity>

Actinic ray curable ink of this invention contains pigment as a colorant. Pigment preferably utilized in this invention will be listed in the following.
C. I. Pigment Yellow-1, 3, 12, 13, 14, 17, 42, 74, 81, 83, 87, 95, 10920, 128, 138, 139, 151, 166, 180, and 185,
C. I. Pigment Orange-16, 36, and 38,
C. I. Red-5, 22, 38, 48:1, 48:2, 48:4, 49:1, 53:1, 57:1, 63:1, 101, 122, 144, 146, 177, and 185,
C. I. Pigment Violet-19, and 23,
C. I. Pigment Blue-15:1, 15:3, 15:4, 18, 27, 29, and 60,
C. I. Pigment Green-7, and 36,
C. I. Pigment White-6, 18, and 21,
C. I. Pigment Black-7,

For dispersion of the above-described pigment, such as a ball mill, a sand mill, an atliter, a roll mill, an agitator, a Henschel mixer, a colloidal mill, an ultrasonic homogenizer, a pearl mill, a wet jet mill and a paint shaker can be utilized. A dispersion medium is preferably a photo-polymerizing compound, and monomer having the lowest viscosity among them is preferably selected with respect to dispersion adaptability.

For dispersion of pigment, it is preferable to perform dispersion under a condition to make the mean particle size of pigment particles of 0.08-0.5 μl, and selection of pigment, a dispersant and a dispersion medium; dispersion condition, and filtration condition are appropriately set so as to make the maximum particle size of 0.3-10 μm and preferably of 0.3-3 μm. By this particle size control, clogging of a head nozzle is depressed and storage stability, transparency and curing sensitivity of ink can be maintained.

In an actinic ray curable composition of this invention, various additives other than those described above can be utilized. For example, incorporated can be a surfactant well known in the art other than fluorine type surfactants according to this invention, a leveling additive, a matting agent; polyester type resin, polyurethane type resin, vinyl type resin, acrylic resin, rubber type resin and waxes to control film physical properties. Further, any basic compound well known in the art can be utilized to improve storage stability; however, typically listed are a basic alkali metal compound, a basic alkaline earth metal compound and a basic organic compound such as amine.

Next, an image forming method of this invention will be explained.

In an image forming method of this invention, preferable is a method in which ink is ejected and drawn on a recording medium by an ink-jet recording method and successively actinic rays such as ultraviolet rays are irradiated to cure ink.

(Ink Ejection Condition)

As an ink ejection condition, ejection is preferably performed while a recording head and ink are heated at 35-100° C. with respect to ejection stability. Since actinic ray curable ink-jet ink exhibits a large viscosity variation width due to temperature variation and the viscosity variation itself significantly influences a droplet size and a droplet ejection speed resulting in deterioration of image quality, it is necessary to keep ink temperature constant while raising the temperature. The control range of ink temperature is preferably a set temperature ±5° C., preferably a set temperature ±2° C. and furthermore preferably a set temperature ±1° C. Further, in this invention, an ink droplet volume ejected from each nozzle is preferably not less than 2 pl and not more than 15 pl.

(Light Irradiation Condition after Ink Deposition)

In an image forming method of this invention, as an irradiation condition of actinic rays, actinic rays are irradiated preferable within 0.001-1.0 second after ink deposition and more preferably within 0.001-0.5 seconds. To form an image having a high precision, it is specifically important that the irradiation timing is as fast as possible.

(Actinic Rays)

In an image forming method of this invention, an ink composition is subjected to light irradiation after having been adhered on a recording medium. Light irradiation may be either visible light irradiation or ultraviolet irradiation, and ultraviolet irradiation is specifically preferable. In the case of ultraviolet irradiation, it is performed at ultraviolet irradiation quantity in a range of not less than 100 mJ/cm² and preferably of not less than 500 mJ/cm², and not more than 10,000 mJ/cm² and preferably not more than 5,000 mJ/cm². At the aforethe amount of ultraviolet irradiation, it is advantageous since curing reaction can be sufficiently performed and fading of a colorant by irradiation of ultraviolet rays can be prevented. A light source of ultraviolet irradiation includes such as a metal halide lamp, a xenon lamp, a carbon arc tube, a chemical lamp, a low pressure mercury lamp, a high pressure mercury lamp. For example, such as H lamp, i) lamp or V lamp produced by Fusion System Corp. which is available on the market can be utilized.

A metal halide lamp has a continuous spectrum and a higher efficiency of emission in a range of 200-450 nm as well as being rich in a long wavelength region, compared to a high pressure mercury lamp (the primary wavelength is 365 nm). Therefore, when pigment is employed, as is the case of an actinic ray curable composition of this invention, a metal halide lamp is suitable.

(Irradiation Method of Actinic Rays)

As an irradiation method of actinic rays, the basic method is disclosed in JP-A 60-132767. According to this disclosure, light sources are arranged on the both sides of a head unit and the head and light sources are scanned in a shuttle mode. Irradiation is performed leaving a predetermined time after ink deposition. Further, curing is completed by another light source without drive. In U.S. Pat. No. 6,145,979, as an irradiation method, disclosed are a method to utilize an optical fiber and a method in which a collimated light source is incident on a mirror surface arranged on the side plane of a head unit and UV light is irradiated on the recoded portion. Any of these irradiation methods can be employed in an image forming method of this invention.

Further, it is also a preferable embodiment in which irradiation of actinic rays is divided into two steps to irradiate actinic rays by the aforesaid method firstly within 0.001-2 seconds after ink deposition and to further irradiate actinic rays after finishing the whole printing. By dividing actinic ray irradiation into two steps, it is possible to restrain shrinkage of a recording medium which is caused at the time of ink curing.

Heretofore, a light source having high illuminance of not less than 1 kW·hr based on the total power consumption is generally utilized to restrain dot broadening and bleeding after ink deposition. However, when these light sources are employed, particularly in printing on a shrinkable label, shrinkage of the recording medium tends to be excessive, that is, these light sources are not viable in practice.

In this invention, it is preferable to utilize actinic rays exhibiting their maximum illuminance in the wavelength range of 254 nm, and an image of high precision can be formed as well as shrinkage of the recording medium can be controlled within allowable levels even when a light source having at least 1 kW·hr of the total power consumption is utilized.

Further in this invention, the total power consumption of the light source to irradiate actinic rays is preferably less than 1 kW·hr. Examples of a light source exhibiting a total power consumption of less than 1 kW·hr include a fluorescent tube, a cold cathode tube, a hot cathode tube and an LED, however, is not limited thereto.

Next, an ink-jet recording apparatus (hereinafter, simply referred to as a recording apparatus) of this invention will be explained.

In the following, the recording apparatus of this invention will be explained, referring to appropriate drawings. Herein, the recording apparatus illustrated in the drawings is only an embodiment of the recording apparatus of this invention and the recording apparatus of this invention is not limited to the drawings.

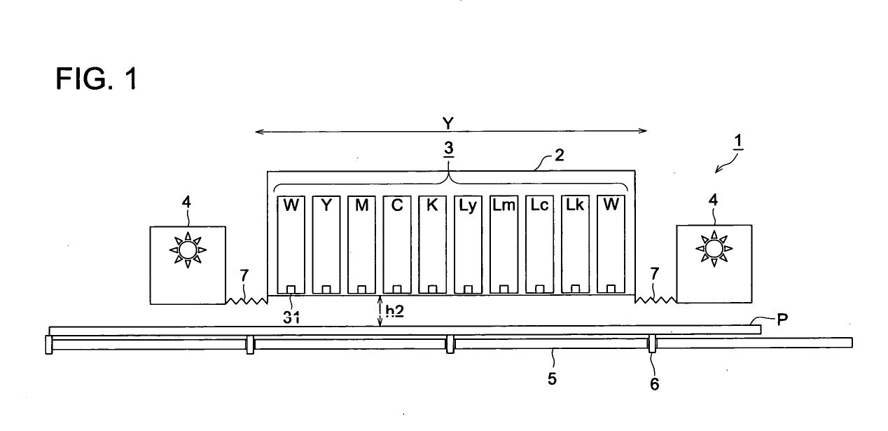

FIG. 1 is a front view showing a constitution of the primary portion of a recording apparatus of this invention. Recording apparatus 1 is typically constituted of such as head carriage 2, recording head 3, irradiation means 4 and platen portion 5. In this recording apparatus 1, platen portion 5 is arranged below recording medium P. Platen portion 5 functions to absorb ultraviolet rays and absorbs excess ultraviolet rays having passed through recording medium P. As a result, an image of high precision can be reproduced very stably.

Recording medium P is guided by guide member 6 and transferred from this side to the interior of FIG. 1 via operation of a conveying means (not shown in the drawing). A head scanning means (also not shown in the drawing) scans via recording head 3 mounted on head carriage 2 by shifting head carriage 2 back and forth along direction Y in FIG. 1.

Head carriage 2 is arranged above recording medium P and carries plural recording heads 3, which will be described later, corresponding to the number of required colors utilized in image printing on recording medium P, while ejection outlets face downward. Head carriage 2 is arranged in a state of being freely shifted back and forth in direction Y in FIG. 1 against the main body of recording apparatus 1, and is transferred back and forth along direction Y in FIG. 1 via drive of the head scanning means.

Herein, in FIG. 1, head carriage 2 is shown so as to store ten sets of recording head 3 comprising white (W), yellow (Y), magenta (M), cyan (C), black (K), light yellow (Ly), light magenta (Lm), light cyan (Lc), light black (Lk) and white (W), however, in practice, the above number of colors feeding recording head 3 carried by head carriage 2 is appropriately determined.

Recording head 3 ejects actinic ray curable ink (such as UV ink) supplied from an ink supply means (not shown in the drawing) toward recording medium P from an ejection orifice via operation of the ejection means (also not shown in the drawing), plural number of orifices are arranged in the interior. UV ink ejected from recording head 3 is typically comprised of such as a colorant, a polymerizing monomer and an initiator, and is provided with the capability of being cured via a cross-linking and/or polymerization reaction incorporation with catalytic action of an initiator during irradiation of ultraviolet rays.

Recording head 3 ejects UV ink as ink droplets within a predetermined region (the region set for ink deposition) of recording medium P during reciprocal scanning to be shifted from one edge of recording medium P to the other edge of recording medium P along direction Y in FIG. 1 via drive of the head scanning means, whereby ink, droplets are deposited within the region set for ink deposition.

After the above-described scanning is performed an appropriate number of times to eject UV ink toward a portion of the region set for ink deposition, recording medium P is shifted from this side to the interior direction of FIG. 1 via a conveying means and UV ink is ejected toward the next region set for ink deposition adjacent to the above-cited region set for ink deposition along the interior direction of FIG. 1 by recording head 3 while again scanning by the head.

By repeating the above-cited operations to eject UV ink from recording head 3 in synchronization of the head scanning means and the conveying means, the targeted image is formed on recording medium P.

Irradiation means 4 is constituted of an ultraviolet lamp which emits ultraviolet rays of a specific wavelength region at stable exposure energy, and a filter which transmits ultraviolet rays of a specific wavelength region. Herein, as an ultraviolet lamp, such as a mercury lamp, a metal halide lamp, an excimer laser, an ultraviolet laser, a cold cathode tube, a hot cathode tube, a black light and a LED (Light Emitting Diode) are applicable, and a metal halide lamp, a cold cathode tube, a mercury lamp or a black light of a band form is preferred. A low pressure mercury lamp, a hot cathode tube, a cold cathode tube and a sterilizing lamp, which emit ultraviolet rays of a wavelength of 254 nm, are specifically preferred, since these lamps can efficiently prevent bleeding and perform dot size control. By employing a black light as a radiation source of irradiation means 4, irradiation means 4 to cure UV ink can be prepared at a low cost.

Irradiation means 4 is provided with a form approximately same as the maximum one of the region which can be set by recorder (UV ink-jet printer) 1, among a region capable of ink deposition by UV ink ejected from recording head 3 in one time scan by drive of a head scanning means, or larger than a region capable of ink deposition.

Irradiation means 4 is arranged by being fixed in nearly parallel to recording medium P on the both sides of head carriage 2.

As described before, as a means to adjust illuminance at an ink ejection portion, the whole of recording head 3 is naturally light shielded; in addition to this, it is effective to set distance h2 between ink ejection portion 31 of recording head 3 and recording medium P larger than distance h1 between irradiation means 4 and recording medium P (h1<h2), or to make distance d between recording head 3 and irradiation means 4 remote (make d large). Further, it is more preferable to provide bellows structure 7 between recording head 3 and irradiation means 4.

Herein, the wavelength of ultraviolet rays irradiated by irradiation means 4 can be appropriately varied by changing an ultraviolet lamp or a filter which is arranged in irradiation means 4.

Actinic ray curable ink of this, invention can also perform image formation by use of a line head type recorder.

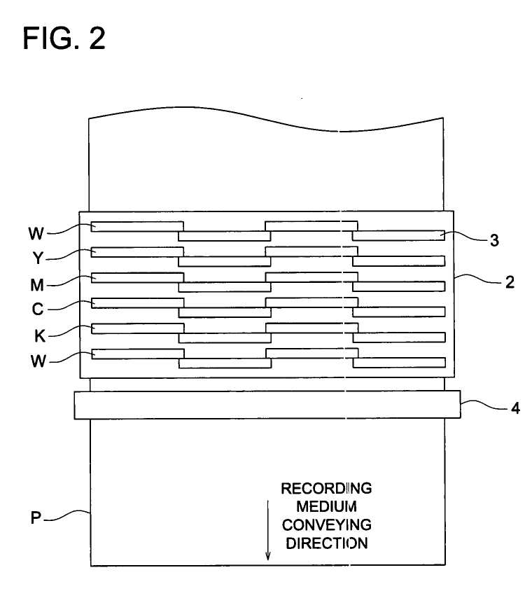

FIG. 2 is an over view to show another example of a constitution of the primary portion of an ink-jet recording apparatus. An ink-jet recording apparatus shown in FIG. 2 is called as a line head type, and plural sets of recording head 3 (6 types of recording heads comprising, two sets of white (W), yellow (Y), magenta (M), cyan (C) and black (B) in FIG. 2) of each color are fixing arranged in head carriage 2 so as to cover the whole width of recording medium P.

On the other hand, in the downstream of head carriage 2, irradiation means 4 is arranged similarly so as to cover the whole width of recording medium P and to cover the whole region of the ink printing surface. As an ultraviolet lamp utilized in irradiation means 4, those similar to one described in FIG. 1 can be employed.

In this line head type, head carriage 2 and irradiation means 4 are fixed, and only recording medium P is transferred to form an image by performing ink ejection and curing. Herein, in this invention, recording medium P is preferably heated at 35-60° C.

Actinic ray curable ink of this invention can also perform image formation by use of a line head type recorder.

FIG. 2 is an over view to show another example of a constitution of the primary portion of an ink-jet recording apparatus. An ink-jet recording apparatus shown in FIG. 2 is called as a line head type, and plural sets of recording head 3 (6 types of recording heads comprising, two sets of white (W), yellow (Y), magenta (M), cyan (C) and black (B) in FIG. 2) of each color are fixing arranged in head carriage 2 so as to cover the whole width of recording medium P.

On the other hand, in the downstream of head carriage 2, irradiation means 4 is arranged similarly so as to cover the whole width of recording medium P and to cover the whole region of the ink printing surface. As an ultraviolet lamp utilized in irradiation means 4, those similar to one described in FIG. 1 can be employed.

In this line head type, head carriage 2 and irradiation means 4 are fixed, and only recording medium P is transferred to form an image by performing ink ejection and curing. Herein, in this invention, recording medium P is preferably heated at 35-60° C.

<Recording Medium>

As a recording medium utilized in this invention, various types of non-absorptive plastic and film thereof, which are employed in so-called soft packaging, in addition to ordinary non-coated paper and coated paper, can be utilized, and various plastic film includes such as polyethylene terephthalate (PET) film, oriented polystyrene (OPS) film, oriented polypropylene (OPP) film, oriented nylon (ONy) film, polyvinyl chloride (PVC) film, polyethylene (PE) film and triacetyl cellulose (TAC) film. In addition to these, such as polycarbonate, acrylic resin, ABS, polyacetal, PVA and rubbers can be utilized. Further, metals and glasses are also applicable.

In this invention, it is advantageous to utilize a long length (a web) recording medium with respect to a cost of recording medium such as packaging expense and a manufacturing cost, preparation efficiency of the printed matter and adaptability to various sizes of prints.

### EXAMPLES

In the following, this invention will be specifically explained referring to examples, however, it is not limited thereto.

### Example 1

### Preparation of Curing Composition (Actinic Ray Curable Composition)

A photo-polymerizing compound, a photo-polymerization initiator, a sliding agent (a fluorine type surfactant, or silicone oil) and other additives, as shown in Table 1, were added and dissolved, whereby curable compositions were prepared. Herein, in curable compositions 5-9, the addition amount of silicone oil utilized in each composition was changed to 0 weights and 0.1 weight %, and an amount of decrease in surface tension at 25° C. of the 0.1 weight % sample against the 0 weight % sample was measured via an automatic surface tension meter CBVP-Z Type, manufactured by Kyowa Interface Science Corp. The results of measurement were to be less than 3 mN/m in any case. Further, viscosity of the ink composition of this invention at 25° C. was determined via a vibration type viscometer to be in the range of 25-35 mPa·s in all cases.

Herein, the details of each compound, described as abbreviations in Table 1, are as follows.

(Photo-Polymerizing Compound)
*1: tetraethylene glycol diacrylate
*2: ε-caprolactam modified dipentaerythrito hexaacrylate
*3: ethylene oxide adduct of trimethylol propanetriacrylate
*4: phenoxethyl methacrylate (Photo-Polymerization Initiator)
*5: Irgacure 184 (Ciba Specialty Chemicals Corp.) (Sliding Agent)

<Fluorine Type Surfactant>
1-31: Exemplary compound 1-31 (C₆F₁₃CH₂CH₂O— (CH₂CH₂O)₁₀—H)
1-41: Exemplary compound 1-41 (C₃F₇CH₂CH₂O— (CH₂CH₂O)₃₁—H)

<Silicone Oil>
KF-351: produced by Shin-Etsu Silicone Co., Ltd.
SDX1843: produced by Asahi Derika Kogyo Co., Ltd.
XF42-334: produced by GE Toshibe Silicone Corp.

TABLE 1

| | Photo- | | | | | | | | | |
|---|---|---|---|---|---|---|---|---|---|---|
| | polymerizing | | | | | | | | | |
| | compound: | | | | | | | | | |
| | addition amount | | | | | | | | | |
| | (weight %) | | | | | | | | | |
| | Radical | | | | Photo- | Sliding agent | | | | |
| Curable | polymerizing | | | | polymerization | Fluorine type | | | | |
| composition | monomer | | | *A | initiator *5 | surfactant | | Silicone oil | | |
| No. | *1 | *2 | *3 | *4 | (weight %) | Type | (weight %) | Type | (weight %) | Remarks |
| 1 | 40 | 27 | 20 | 3 | 10 | — | — | — | — | Comparison |
| 2 | 25 | 17 | 13 | 35 | 10 | — | — | — | — | Comparison |
| 3 | 40 | 27 | 20 | 3 | 9.8 | — | — | KF-351 | 0.2 | Comparison |
| 4 | 40 | 20 | 20 | 10 | 9.8 | 1-41 | 0.2 | — | — | Invention |
| 5 | 40 | 20 | 20 | 10 | 9.8 | — | — | KF-351 | 0.2 | Invention |
| 6 | 40 | 20 | 15 | 15 | 9.8 | — | — | KF-351 | 0.2 | Invention |
| 7 | 34 | 17 | 9 | 30 | 9.8 | — | — | KF-351 | 0.2 | Invention |
| 8 | 40 | 20 | 15 | 15 | 9.8 | — | — | SDX1843 | 0.2 | Invention |
| 9 | 40 | 20 | 15 | 15 | 9.8 | — | — | XF42-334 | 0.2 | Invention |
| 10 | 40 | 20 | 15 | 15 | 9.8 | 1-31 | 0.2 | — | — | Invention |

*A: mono-functional radical monomer

<Evaluation of Curable Composition>

[Evaluation of Curing Sensitivity]

After coating the prepared curable composition onto synthetic paper (Synthetic Paper Upo FG, produced by Upo Corp.) so as to make a layer thickness of 3 μm, ultraviolet rays were emitted at varying strength and duration and the cured layer after irradiation was scratched by a finger nail to determine curing sensitivity based on irradiation energy (mJ/cm₂) when the cured layer was peeled off.

[Evaluation of Flexibility]

After a curable composition was coated onto a synthetic paper (Synthetic Paper Upo FG, produced by Upo Corp.) so as to make a layer thickness of 40 μm, the sample was irradiated by use of a high pressure mercury lamp (HN-64NL, manufactured by Japan Storage Battery Co., Ltd.) to prepare a cured product. The prepared cured layer was evaluated based on a method of Bend Test of JIS K 5600.

[Evaluation of Abrasion Resistance]

After a curable composition had been coated onto a synthetic paper (Synthetic Paper Upo FG, produced by Upo Corp.) so as to make a layer thickness of 40 μm, the sample was irradiated by use of a high pressure mercury lamp (HN-64NL, manufactured by Japan Storage Battery Co., Ltd.) to prepare a cured product. The prepared cured layer was scratched by a finger nail to evaluate abrasion resistance based on the following criteria.
5: No scratched mark was generated even when the layer was strongly scratched with a finger nail.
4: Few slight scratches were generated even when the layer was strongly scratched with a finger nail.
3: More scratches than in 4 were generated when the layer was strongly scratched with a finger nail; however, it was not problematic in practice.
2: More scratches than in 3 were generated when the layer was strongly scratched with a finger nail, and it was problematic viability
1: Obvious scratches were easily generated even when the layer was weakly scratched with a finger nail.

The results obtained above are shown in Table 2.

TABLE 2

| | Each evaluation results | | | |
|---|---|---|---|---|
| Curable | | Curing | | |
| composition | | sensitivity | Abrasion | |
| No. | Flexibility | (mJ/cm²) | resistance | Remarks |
| 1 | Cracks are | 500 | 3 | Comparison |
| | generated | | | |
| | even with | | | |
| | 10 mmφ | | | |
| 2 | 5 mmφ | 800 | 1 | Comparison |
| 3 | Cracks are | 500 | 4 | Comparison |
| | generated | | | |
| | even with | | | |
| | 10 mmφ | | | |
| 4 | 7 mmφ | 500 | 4 | Invention |
| 5 | 7 mmφ | 500 | 5 | Invention |
| 6 | 8 mmφ | 550 | 4 | Invention |
| 7 | 3 mmφ | 600 | 5 | Invention |
| 8 | 4 mmφ | 550 | 5 | Invention |
| 9 | 4 mmφ | 550 | 5 | Invention |
| 10 | 4 mmφ | 550 | 4 | Invention |

It is clear from the results described in Table 2 that actinic ray curable compositions of this invention exhibit no decrease in sensitivity and can produce a strong and flexible cured product. Further, various types of curable compositions were prepared in a similar manner to preparation of curable compositions 4 and 10, except that fluorine type surfactants 1-14 and 1-31 represented by Formula (1) were changed to fluorine type surfactants 2-20 and 2-26 represented by Formula (2) and fluorine type surfactants 3-12, 3-32 and 3-46 represented by Formula (3), respectively, and similar evaluations were conducted to obtain similar effects to curable compositions 4 and 10.

### Example 2

### Preparation of Ink Composition Set

Dispersant (PB822, produced by Ajinomoto Fine-Techno Co., Inc.) of 5 weight parts, each photo-polymerizing compound and the mono-functional radical monomer described in Table 3 were charged into a stainless steel beaker, and dissolved by stirring and mixing while being heated at 65° C. on a hot plate over 1 hour. Successively, the resulting solution, to which added were various pigments (7 types), was poured into a polyethylene bottle, together with 200 g of zirconia beads having a diameter of 1 mm and sealed, followed by being subjected to a dispersion treatment for 2 hours by use of a paint shaker. Next, the zirconia beads were removed, each of various additives such as each polymerization initiator and surfactant being added as a combination described in Table 3, and the resulting mixture was filtered through a 0.8 μm membrane filter to prevent printer clogging, whereby ink composition sets 1-7 constituted of each curable composition of deep color ink (yellow ink (Y), magenta ink (M), cyan ink (C) and black ink (K)) and light color ink (light magenta ink (Lm), light cyan ink (Lc) and light black ink (Lk)) were prepared. Herein, in preparation of color curable composition inks of each color, the addition amount of various pigments was 4 weight % for the deep color ink of K, C, M and Y; while the addition amount of various pigments was 0.8 weight % for light color ink of Lk, Lc and Lm, as described in Table 3. Further, curable compositions were separately prepared by changing the addition amount of silicone oil utilized in preparation of ink composition sets 4-7 to 0 weight % and 0.1 weight %; an amount of decrease in surface tension of a 0.1 weight % addition level compared to 0 weight % level at 25° C. was measured by use of Automatic Surface Tension Meter CBVP-Z Type, manufactured by Kyowa Interface Science Co., Ltd., to be less than 3 mN/m in any case. Further, viscosity of ink composition sets of this invention at. 25° C. was measured by use of a vibration type viscometer and fell into the range of 25-35 mPa·s.

The details of each compound described in Table 3 are as follows.

*1-*5, 1-31, KF-351, SDX1843 and XF42-334 are the same as the compounds described in Table 1.

(Dispersant)

PB822: Ajisper PB822, produced by Ajinomoto Fine-Techno Co., Inc.

(Pigment)

Although it is not described in Table 3, pigment utilized in each color curable composition ink to constitute an ink composition set is as follows.

Yellow Ink (Y): C. I. Pigment Yellow 13

Magenta Ink (M): C. I. Pigment Red 57:1

Cyan Ink (C): C. I. Pigment Blue 15:3

Black Ink (K): C. I. Pigment Black 7

Light Magenta Ink (Lm): C. I. Pigment Red 57:1

Light Cyan Ink (Lc): C. I. Pigment Blue 15:3

Light Black Ink (Lk): C. I. Pigment Black 7

TABLE 3

| | | Photo- | | | | | | | | | | | |
|---|---|---|---|---|---|---|---|---|---|---|---|---|---|
| | | polymerizing | | | | | | | | | | | |
| | | compound: | | | | | | | | | | | |
| | | addition amount | | | | | | | | | | | |
| | | (weight %) | | | | | | | | | | | |
| | | Radical | | | | Photo- | Sliding agent | | | | | | |
| Ink | | polymerizing | | | | polymerization | Fluorine type | | | | Dispersant | | |
| composition | Ink | monomer | | | *A | initiator | surfactant | | Silicone oil | | PB822 | Pigment | |
| set | type | *1 | *2 | *3 | *4 | *5 (weight %) | Type | (weight %) | Type | (weight %) | (weight %) | (weight %) | Remarks |
| 1 | *B | 35 | 27 | 20 | 3 | 10 | — | — | — | — | 1 | 4.0 | Comp. |
| | *C | 35 | 27 | 23.2 | 3 | 10 | — | — | — | — | 1 | 0.8 | |
| 2 | *B | 21 | 17 | 12 | 35 | 10 | — | — | — | — | 1 | 4.0 | Comp. |
| | *C | 21 | 17 | 15.2 | 35 | 10 | — | — | — | — | 1 | 0.8 | |
| 3 | *B | 30 | 23 | 17 | 15 | 9.8 | 1-31 | 0.2 | — | — | 1 | 4.0 | Inv. |
| | *C | 30 | 23 | 20.2 | 15 | 9.8 | 1-31 | 0.2 | — | — | 1 | 0.8 | |
| 4 | *B | 30 | 23 | 17 | 15 | 9.8 | — | — | KF-351 | 0.2 | 1 | 4.0 | Inv. |
| | *C | 30 | 23 | 20.2 | 15 | 9.8 | — | — | KF-351 | 0.2 | 1 | 0.8 | |
| 5 | *B | 30 | 23 | 17 | 15 | 9.8 | — | — | SDX1843 | 0.2 | 1 | 4.0 | Inv. |
| | *C | 30 | 23 | 20.2 | 15 | 9.8 | — | — | SDX1843 | 0.2 | 1 | 0.8 | |
| 6 | *B | 30 | 23 | 17 | 15 | 9.8 | — | — | XF42-334 | 0.2 | 1 | 4.0 | Inv. |
| | *C | 30 | 23 | 20.2 | 15 | 9.8 | — | — | XF42-334 | 0.2 | 1 | 0.8 | |
| 7 | *B | 24 | 18 | 13 | 30 | 9.8 | — | — | KF-351 | 0.2 | 1 | 4.0 | Inv. |
| | *C | 24 | 18 | 16.2 | 30 | 9.8 | — | — | KF-351 | 0.2 | 1 | 0.8 | |

*A: mono-functional radical monomer,
*B: Deep color ink,
*C: Light color ink
Comp.: Comparison,
Inv.: Invention

<Ink-jet Image Forming Method>

Each ink composition set prepared as above was loaded into an ink-jet recording apparatus having the constitution described in FIG. 1, which was equipped with piezo-type ink-jet nozzles, and the following image, recording was continuously performed on each roll-form recording medium of having a width of 600 mm and a length of 20 m. The ink supply system was constituted of an ink tank, a supply pipe, a pre-chamber ink tank immediately before the head, piping equipped with a filter and a piezo-head, and the portion from the pre-chamber tank to the head was heat insulated and heated at 50° C. The head portion was heated based on the specific viscosity of each curable composition ink constituting each ink composition set, and driven so as to eject multi-sized dots of 2-15 pl at a resolution of 720×720 dpi (dpi referred to in this invention is a dot number per inch or 2.54 cm), whereby the above-described curable ink composition was continuously ejected. The ink was almost instantaneously cured (within less than 0.5 second after ink deposition) after ink deposition by irradiation at light quantity of 1,000 mW/cm² via a mercury lamp of 80 W/cm (NH-64NL manufactured by Nippon Battery Ltd.) arranged on both sides of a head carriage. After image recording, the total ink layer thickness was determined to be in the range of 2-60 μm. Herein, for ink-jet image formation, printing was performed under an environment of 25° C. and 20% RH according to the above-described method.

Herein, illuminance of each irradiation light source was measured based on accumulated illuminance at 254 nm by use of UVPF-A1, manufactured by Iwasaki Electric Co., Ltd.

Further, the details of each recording medium described by abbreviations in Table 4 are as follows.

Synthetic paper: Synthetic Paper Upo FGS, produced by Upo Corp.

PVC: polyvinyl chloride

<Evaluation of Printed Image>

[Evaluation of Bleeding Resistance]

Printing on synthetic paper and PVC at 720 dpi was performed so that dots of Y, M, C, K, Lk, Lc and Lm colors are adjacent to each other, and each color dot was magnified through a jeweler loupe to visually observe the degree of bleeding and wrinkling, whereby color mixing was evaluated based on the following criteria.

A: Adjacent dot shapes remained a true circle without bleeding.

B: Adjacent dot shapes remained a nearly true circle with little bleeding.

C: Adjacent dots showed slight bleeding and dots were slightly deformed; however, it was at a barely usable level.

D: Adjacent dots showed obvious bleeding and mixing, and wrinkles were generated at the bled portions of dots; and it was considered to be an unusable level.

[Evaluation of Flexibility]

With respect to an image formed by printing on synthetic paper (Synthetic Paper Upo FGS, produced by Upo Corp.) so as to make a layer thickness of 80 μm, a bending test was performed, whereby flexibility was evaluated according to the following criteria.

5: No change at all of the ink layer was noted when being bent.

4: Color change was generated but no cracks were noted at the bend.

3: Slight cracks were generated at the bends; however, it was acceptable for practical use.

2: The ink layer could be easily peeled off at the wrinkled portions when being bent, and it was impractical for commercial use.

1: Cracks were generated and image portions fell away when only curled.

[Evaluation of Abrasion Resistance]

After coating had been performed on synthetic paper (Synthetic Paper Upo FGS, produced by Upo Corp.) so as to make a layer thickness of 40 μm, the image surface, which was formed by printing and irradiation with a high pressure mercury lamp (NH-64NL, manufactured by Japan Storage Battery Co., Ltd.) after 0.1 second following ink deposition, was scratched with a finger nail, whereby abrasion resistance was evaluated according to the following criteria.

5: No flaws were generated even when being strongly scratched with a finger nail.

4: only slight flaws were generated even when being strongly scratched with a finger nail.

3: Weak flaws were generated when being strongly scratched with a finger nail; however it was not problematic for practical use.

2: Obvious flaws were generated when being strongly scratched with a finger nail; and it was considered impractical for commercial use.

1: Flaws were easily generated even when being weakly scratched with a finger nail.

[Evaluation of Ink Ejection Behavior]

After each color ink was continuously ejected for 30 minutes, each nozzle was visually observed for clogging and the average state of clogging for each color nozzle was evaluated based on the following criteria.
A: No nozzle clogging was observed and was evaluated as a good state.
B: Slight nozzle clogging was observed; however, it was not problematic for commercial use.
C: Some nozzle clogging was observed and was at a level to adversely influence on image quality.
D: Nozzle clogging was frequent and it was considered to be at an unviable level.

Evaluation results obtained above are shown in Table 4.

TABLE 4

| | Each evaluation result | | | | | |
|---|---|---|---|---|---|---|
| | Bleeding | | | | | |
| | resistance | | | | Ink | |
| Ink composition | | Synthetic | | Abrasion | ejection | |
| set No. | PVC | paper | Flexibility | resistance | behavior | Remarks |
| 1 | A | A | 1 | 3 | C | Comparison |
| 2 | C | D | 5 | 1 | A | Comparison |
| 3 | A | A | 4 | 4 | A | Invention |
| 4 | A | A | 4 | 5 | A | Invention |
| 5 | A | A | 5 | 5 | A | Invention |
| 6 | A | A | 5 | 5 | A | Invention |
| 7 | B | B | 5 | 5 | A | Invention |

It is clear from the results of Table 4 that ink composition sets comprising actinic ray curable inks of this invention, when compared to comparative examples, exhibit excellent bleeding resistance and flexibility of the image, even when formed under low humidity, as well as excellent abrasion resistance and ink ejection behavior.

1. An actinic ray curable composition comprising a radical polymerizing monomer,
wherein the radical polymerizing monomer contains a mono-functional monomer, a content of which is not less than 5 weight % and not more than 30 weight %, and further contains a silicone-containing compound or a fluorine-containing compound.

2. The actinic ray curable composition described in claim 1,
wherein the radical polymerizing monomer is an acrylate compound or a methacrylate compound.

3. The actinic ray curable composition described in claim 1,
wherein the silicone-containing compound is a silicone oil.

4. The actinic ray curable composition described in claim 3,
wherein an amount of decrease in surface tension at 25° C. is 0-3 mN/m when 0.1 weight % of the silicone oil is incorporated based on the total weight of the composition.

5. The actinic ray curable composition described in claim 1,
wherein the fluorine-containing compound is a fluorine-containing surfactant.

6. The actinic ray curable composition described in claim 5,
wherein the fluorine-containing surfactant is at least one type selected from fluorine-containing surfactants represented by Formulas (1)-(3):
Rf-(L₁)ₘ-(Y₁)ₙ—X Formula (1)
wherein Rf is an aliphatic group containing at least one fluorine atom; L₁ is a divalent connecting group; Y₁ is an alkylene oxide group or an alkylene group which may be provided with a substituent; X is a hydrogen atom, a hydroxyl group, an anionic group or a cationic group; m is 0 or an integer of 1-5 and n is 0 or an integer of 1-40,
Rf—(O—Rf′)ₙ₁-L₂-X′ₘ₁ Formula (2)
wherein Rf is an aliphatic group Containing at least one fluorine atom; Rf′ is an alkylene group containing at least one fluorine atom; L₂ is a simple bonding hand or a connecting group; X′ is a hydroxyl group, an anionic group or a cationic group; n1 and m1 are each an integer of not less than 1, and
[(Rf″O)ₙ₂—(PFC)—CO—Y₂]ₖ-L₃-X″ₘ₂ Formula (3)
wherein Rf″ is a perfluoroalkyl group containing 1-4 carbon atoms; (PFC) is a perfluorocyclcalkylene group; Y₂ is a connecting group containing an oxygen atom or a nitrogen atom; L₃ is a simple bonding hand or a connecting group; X″ is a water-solubilizing polar group containing an anionic group, a cationic group, a nonionic group or an amphoteric group; n2 is an integer of 1-5; k is an integer of 1-3; m2 is an integer of 1-5.

7. The actinic ray curable composition described in claim 1,
wherein viscosity at 25° C. is not less than 7 mPa·s and not more than 40 mPa·s.

8. An actinic ray curable ink comprising the actinic ray curable composition described in claim 1, and the composition contains a pigment.

9. An image forming method comprising the steps of:
(a) ejecting the actinic ray curable ink described in claim 8 from an ink-jet recording head onto a recording medium, and
(b) irradiating actinic rays to the ejected ink to print an image onto the printing medium,
wherein the actinic ray curable ink is irradiated by actinic rays during not less than 0.001 second and not more than 0.1 second after deposition of the ink.

10. The image forming method described in claim 9,
wherein a minimum droplet volume, which is ejected from each nozzle of the ink-jet recording head, is not less than 2.0 pl and not more than 15 pl.

11. An ink-jet recording apparatus utilized in the image forming method described in claim 9,
wherein the actinic ray curable ink is ejected from an ink-jet recording head after the actinic ray curable ink and the ink-jet recording head are heated to 35-100° C.
